(19) United States
(12) Patent Application Publication
(10) Pub. No.: US 2026/0255006 A1
(43) Pub. Date: Aug. 27, 2026

(54) LIVE STREAMING RECOMMENDATION

(71) Applicant: Beijing Zitiao Network Technology Co., Ltd., Beijing (CN)

(72) Inventors: Rui LI, Beijing (CN); Pengyuan GAO, Beijing (CN); Haihan LI, Beijing (CN); Ling CHAI, Beijing (CN); Shaohao HUANG, Beijing (CN); Ting XIE, Beijing (CN)

(21) Appl. No.: 19/533,861

(22) Filed: Feb. 9, 2026

(30) Foreign Application Priority Data
Feb. 26, 2025 (CN) 202510216627.9

(51) Int. Cl. H04N 21/25; H04N 21/2187; H04N 21/24

(52) U.S. Cl. CPC H04N 21/251; H04N 21/2187; H04N 21/2407

(57) ABSTRACT

The proposed live streaming recommendation method includes: determining a plurality of traffic feature sequences of a live stream that correspond to a plurality of interaction operations, where the plurality of interaction operations is initiated by viewing users in the live stream, and in each of the plurality of traffic feature sequences, different traffic features represent feature information corresponding to an interaction operation in different historical time slices of the live stream; determining, at least based on the plurality of traffic feature sequences, predicted traffic changes of the live stream respectively corresponding to the plurality of interaction operations in a target time slice; and determining a recommendation degree of the live stream for a user group at least based on a recommendation request of the user group and the predicted traffic changes of the live stream respectively corresponding to the plurality of interaction operations in the target time slice.

### CROSS-REFERENCE

The present application claims priority to Chinese Patent Application No. 202510216627.9, filed on Feb. 26, 2025, and entitled “METHOD, APPARATUS, DEVICE AND STORAGE MEDIUM FOR LIVE STREAMING RECOMMENDATION”, which is incorporated herein by reference in its entirety.

### FIELD

Example embodiments of the present disclosure generally relate to the field of computer technology and, in particular, to live streaming recommendation.

### BACKGROUND

Live streaming is a form of communication that uses Internet technologies to synchronously produce and distribute content, enabling viewers to watch and participate in real-time interactions. In a live streaming service, the user is recommended to watch the live streaming content according to the needs. However, traditional live streaming recommendation schemes generally recommend live streaming based on the perspective of the audience, which may cause some high-quality content to be underestimated during the recommendation process.

### SUMMARY

In a first aspect of the present disclosure, a method for live streaming recommendation is provided. The method includes: determining a plurality of traffic feature sequences of a live stream that correspond to a plurality of interaction operations, where the plurality of interaction operations is initiated by viewing users in the live stream, and in each of the plurality of traffic feature sequences, different traffic features represent feature information corresponding to interactions operation in different historical time slices of the live stream; determining, at least based on the plurality of traffic feature sequences, predicted traffic changes of the live stream respectively corresponding to the plurality of interaction operations in a target time slice; and determining a recommendation degree of the live stream for a user group at least based on a recommendation request of the user group and the predicted traffic changes of the live stream respectively corresponding to the plurality of interaction operations, in the target time slice.

In a second aspect of the present disclosure, an apparatus for livestreaming recommendation is provided. The apparatus includes: a traffic feature sequence determining module configured to determine a plurality of traffic feature sequences of a live stream that correspond to a plurality of interaction operations, where the plurality of interaction operations is initiated by viewing users in the live stream, and in each of the plurality of traffic feature sequences, different traffic features represent feature information corresponding to interaction operations in different historical time slices of the live stream; a predicted traffic change determining module configured to determine, at least based on the plurality of traffic feature sequences, predicted traffic changes of the live stream respectively corresponding to the plurality of interaction operations in a target time slice; and a recommendation degree determining module configured to determine a recommendation degree of the live stream for a user group at least based on a recommendation request of the user group and the predicted traffic changes of the live stream respectively corresponding to the plurality of interaction operations in the target time slice.

In a third aspect of the present disclosure, an electronic device is provided. The device includes at least one processor; and at least one memory, the at least one memory being coupled to the at least one processor and storing instructions executable by the at least one processor, where the instructions, when executed by the at least one processor, cause the device to perform the method of the first aspect.

In a fourth aspect of the present disclosure, a computer-readable storage medium is provided. The computer-readable storage medium has computer-executable instructions stored thereon, where the computer-executable instructions are executable by a processor to implement the method of the first aspect.

In a fifth aspect of the present disclosure, a computer program product is provided. The computer program product includes computer-executable instructions, where the computer-executable instructions, when executed by a processor, implement the method according to the first aspect of the present disclosure.

It should be understood that the content described in this summary section is not intended to identify key or important features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description.

In the drawings, the same or similar reference numerals refer to the same or similar elements, where:

FIG. 1 shows a schematic diagram of an example environment in which embodiments of the present disclosure may be implemented;

FIG. 2 shows a flowchart of an example process of a live streaming recommendation method according to some embodiments of the present disclosure;

FIG. 3 shows a schematic diagram of an example architecture of a content recommendation system according to some embodiments of the present disclosure;

FIG. 4 shows a schematic diagram of an example of determining a traffic change label according to some embodiments of the present disclosure;

FIG. 5 shows a schematic diagram of an example of determining predicted traffic changes according to some embodiments of the present disclosure;

FIG. 6 shows a schematic diagram of an example of adjusting a recommendation ranking according to some embodiments of the present disclosure;

FIG. 7 shows a schematic structural block diagram of an apparatus for live streaming recommendation according to some embodiments of the present disclosure; and

FIG. 8 shows a block diagram of an electronic device in which one or more embodiments of the present disclosure may be implemented.

### DETAILED DESCRIPTION OF EMBODIMENTS

Embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. On the contrary, these embodiments are provided for a more thorough and complete understanding of the present disclosure. It should be understood that the drawings and embodiments of the present disclosure are only for illustrative purposes, and are not intended to limit the protection scope of the present disclosure.

It should be noted that the titles of any sections/subsections provided herein are not restrictive. Various embodiments are described throughout this article, and any type of embodiment may be included under any section/subsection. In addition, the embodiments described in any section/subsection may be combined with any other embodiments described in the same section/subsection and/or different sections/subsections in any manner.

In the description of the embodiments of the present disclosure, the term “include/comprise” and similar terms should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. Other explicit and implicit definitions may also be included below. The terms “first”, “second”, etc. may refer to different or same objects. Other explicit and implicit definitions may also be included below.

The embodiments of the present disclosure may involve user's data, data acquisition, and/or data use, etc. All these aspects comply with corresponding laws, regulations, and related provisions. In the embodiments of the present disclosure, all data collection, acquisition, processing, machining, forwarding, use, etc., are carried out on the premise that the user is aware and confirms. Accordingly, when implementing the embodiments of the present disclosure, the user should be informed of the type, range of use, use scenarios, etc., of the data or information that may be involved and obtain the user's authorization in an appropriate manner in accordance with relevant laws and regulations. The specific manner of informing and/or authorizing may vary according to the actual situation and application scenarios, and the scope of the present disclosure is not limited in this regard.

If the solutions in the specification and embodiments involve personal information processing, the processing is performed on the premise that there is a legal basis (for example, the consent of the personal information subject is obtained, or it is necessary for the performance of a contract, etc.), and the processing is only performed within the scope of provisions or agreements. If the user refuses to process personal information other than the necessary information required for the basic functions, it will not affect the user's use of the basic functions.

As briefly described above, traditional live streaming recommendation schemes generally recommend live stream based on the perspective of the audience, which may cause some high-quality content to be underestimated during the recommendation process. Specifically, compared with traditional videos, as an interactive medium between a streamer (also referred to as a live streaming supplier) and an audience (also referred to as a live streaming demander), live stream has a production process and an extraction process that exist and influence each other at the same time. For example, assuming that the streamer successively performs activities such as “chatting with the audience” and “dancing performance”, the traffic efficiency of different activities will show significant differences. The traffic efficiency may be an indicator used to measure the performance of the live streaming content in attracting the audience to watch and promoting the interaction of the audience, and the traffic efficiency may be determined based on the number of comments and/or the number of likes from the audience, etc. Compared with “chatting with the audience”, when the streamer is performing the “dancing performance”, the number of comments and/or the number of likes from the audience are often higher. This means that high-quality live streaming content can attract the audience to actively participate in the interaction, thereby improving the traffic efficiency. Such positive feedback in turn affects the live streaming method of the streamer, prompting the streamer to be more inclined to provide high-quality content in the future (such live streaming content is also referred to as potential high-quality content below).

Traditional live streaming recommendation schemes generally recommend the audience live stream that they may be interested in based on their historical viewing data. Such a live streaming recommendation scheme does not consider the interaction between the audience and the live stream, which leads to the above-mentioned potential high-quality content being underestimated during the recommendation process.

In view of this, embodiments of the present disclosure provide a live streaming recommendation scheme. According to the scheme, first, a plurality of traffic feature sequences of a live stream that correspond to a plurality of interaction operations are determined, where the plurality of interaction operations is initiated by viewing users in the live stream, and in each of the plurality of traffic feature sequences, different traffic features represent feature information of the live stream corresponding to interaction operations in different historical time slices. Then, predicted traffic changes of the live stream respectively corresponding to the plurality of interaction operations in a target time slice are determined at least based on the plurality of traffic feature sequences (for the convenience of discussion, these predicted traffic changes are also collectively or individually referred to as interaction traffic changes below). Then, a recommendation degree of the live stream for a user group is determined at least based on a recommendation request of the user group and the predicted traffic changes of the live stream respectively corresponding to the plurality of interaction operations in the target time slice.

It will be understood more clearly through the description below that the live streaming recommendation scheme proposed in the present disclosure is carried out based on a live stream (which may also be referred to as a transmission carrier of live streaming content in a live streaming room). Such a live streaming recommendation scheme may comprehensively capture interaction operations (such as comments and/or likes, etc.) of viewing users (which may also be referred to as an audience) during the live streaming process based on the perspective of the live streaming room. Further, the scheme of the present disclosure performs feature extraction on the interaction operations in the live stream based on historical time slices (for example, extracting feature information based on minute-level historical time slices) and constructs corresponding traffic feature sequences. Such traffic feature sequences may reflect the traffic efficiency of the live streaming content in a recent period of time in real time. Based on such traffic feature sequences, the scheme of the present disclosure may accurately predict the subsequent interaction traffic changes (for example, an increase in comment traffic or a decrease in comment traffic) of the live stream, thereby identifying whether the live stream is the potential high-quality content as described above. In the case where the live stream is the potential high-quality content as described above, the embodiments of the present disclosure may increase the recommendation degree of the live stream, so as to prevent such live streaming content from being underestimated during the recommendation process.

In this way, the scheme of the present disclosure can provide more positive feedback for the streamer, thereby optimizing the live streaming experience of the streamer. Positive feedback is conducive to promoting the emergence of more high-quality content, thereby improving the viewing experience of the live streaming audience at the same time. Therefore, the scheme of the present disclosure can optimize the bilateral experience of the streamer and the audience at the same time, which makes the recommendation process more in line with the characteristics of the live streaming scenario, thereby improving the accuracy of the live streaming recommendation.

Various example implementations of the scheme will be described in detail below in further conjunction with the drawings.

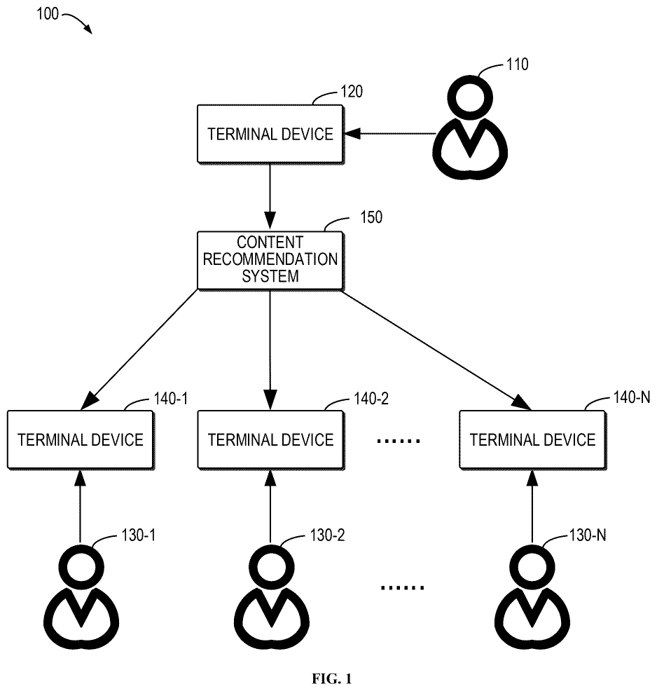

FIG. 1 shows a schematic diagram of an example environment 100 in which embodiments of the present disclosure may be implemented. In the environment 100, a user 110 may be referred to as a streamer, a live streaming party or a live streaming supplier of a live streaming room. The user 110 may create and manage the live streaming room through an associated terminal device 120, so as to provide various live streaming content including audio and/or video. It should be noted that although only one streamer is shown in FIG. 1, in practice, a live streaming room may be jointly initiated and managed by multiple streamers to meet a wider range of user needs.

In the environment 100, users 130-1 to 130-N may be referred to as an audience, viewing users, viewing parties or participating parties, etc. in the live streaming room, where N is a positive integer. The users 130-1 to 130-N may watch the live streaming content and participate in the interaction in the live streaming room through respective associated terminal devices 140-1 to 140-N. The terminal devices 140-1 to 140-N may present a live streaming interface to ensure that the audience may watch the live streaming clearly and smoothly. For the convenience of discussion, the users 130-1 to 130-N are also collectively or individually referred to as a user 130 below, and the corresponding terminal devices are also collectively or individually referred to as a terminal device 140.

In the environment 100, the terminal device 120 and the terminal device 140 are not only used to present the livestreaming content, but may also communicate with a content recommendation system 150 through communication methods such as a network. The content recommendation system 150 may be an application, a website, a web page, and other accessible platforms. The terminal device 120 and the terminal device 140 may be installed with applications for accessing the content recommendation system 150, or the terminal device 120 and the terminal device 140 may access the content recommendation system 150 in any suitable manner.

The content recommendation system 150 may be configured to recommend live streaming content of one or more streamers to a user group (for example, the users 130-1 to 130-N) based on a corresponding strategy.

For example, the content recommendation system 150 may recommend live streaming content that may be of interest to the user 130 to the user 130 based on the user's 130 historical viewing data.

In the environment 100, the terminal device 130 may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the above, including the accessories and peripherals of these devices or any combination thereof. In some embodiments, the terminal device 130 may also support any type of user-specific interface (such as “wearable” circuitry, etc.).

In the environment 100, the content recommendation system 150 may be deployed in any type of server device. The server device may be an independent physical server, a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server device may include, for example, a computing system/server, such as a mainframe, an edge computing node, a computing device in a cloud environment, and so on.

It should be understood that the structure and function of each element in the environment 100 are described for illustrative purposes only, and do not imply any limitation on the scope of the present disclosure.

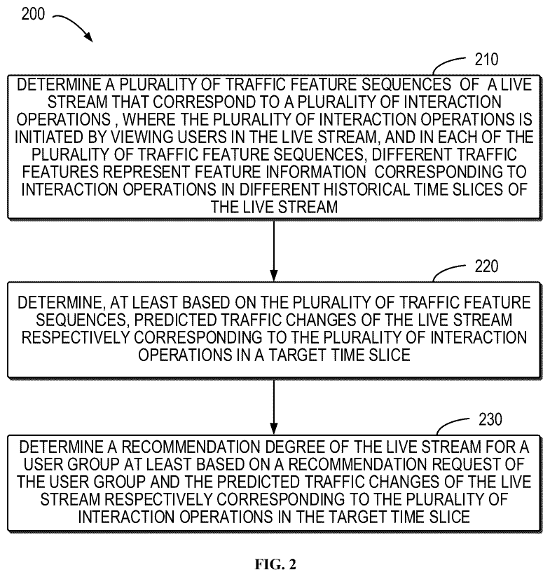

FIG. 2 shows a flowchart of an example process 200 of a live streaming recommendation method according to some embodiments of the present disclosure. The process 200 may be implemented at the content recommendation system 150.

Referring to FIG. 2, at a block 210, the content recommendation system 150 determines a plurality of traffic feature sequences of a live stream that correspond to a plurality of interaction operations. The plurality of interaction operations is initiated by viewing users (e.g., the user 130) in the live stream. In the traffic feature sequence corresponding to each interaction operation, different traffic features represent feature information of the live stream corresponding to the interaction operation in different historical time slices.

As an example, the live stream may be a transmission carrier of live streaming content in a live streaming room. In the case where a streamer (for example, the user 110) starts a live stream, the live streaming content may be processed into a live stream, which is transmitted to each viewing user (for example, the terminal device 140) in real time. In this way, regardless of where the viewing user is, as long as there is a network connection, the viewing user may instantly watch the streamer's live streaming content. In addition, the live stream also carries the interaction data of the live streaming room. In the process of the live stream, the viewing user may interact with the streamer through a comment operation and/or a like operation. These interaction data will also be included in the live stream and transmitted to the streamer (for example, the terminal device 120) and other viewing users in real time.

As an example, the plurality of interaction operations may be various interactions initiated by the viewing user during the live stream, and these interactions may be interactions that can reflect the participation and interest points of the viewing user during the live stream. As an example, the plurality of interaction operations may include a comment operation and/or a like operation of the viewing user. It should be noted that the above is only an example. According to actual needs, the interaction operations in the embodiments of the present disclosure may include more operations such as a virtual gift giving operation and a sharing operation, which is not limited in the embodiments of the present disclosure.

As an example, a time slice may be several segments that the content recommendation system 150 divides the live stream into according to the time sequence. The historical time slice may be a time slice of the live stream that is before the current moment. As an example, the time slice may be a segment in minutes. For example, the time slice may be a segment in units of 1 minute, 5 minutes, 10 minutes, etc. It should be noted that the above is only an example. According to actual needs, the time slice may also be a segment in units of 15 minutes, which is not limited in the embodiments of the present disclosure.

As an example, the feature information in each historical time slice may be quantitative data or indicators of the corresponding interaction operation in the historical time slice. As an example, the feature information corresponding to the comment operation may indicate the number of comments or the ratio of the number of comments to the number of viewing users (which may also be referred to as the comment rate), etc. It should be noted that the above is only an example. According to actual needs, the feature information may also indicate more content, for example, the feature information corresponding to the follow operation may indicate the number of follows and the follow rate, etc., which is not limited in the embodiments of the present disclosure. The traffic feature may represent one or more types of feature information of the corresponding interaction operation in a single historical time slice. For example, the traffic feature corresponding to comments may represent the number of comments and the comment rate at the same time. The traffic feature may be used to measure the effectiveness of the corresponding historical time slice in attracting the audience to watch and promoting the audience's interaction, etc. Therefore, such a traffic feature may indicate the traffic efficiency of the corresponding historical time slice. In the embodiments of the present disclosure, the traffic efficiency may be defined as the interaction rate between the viewing user and the live stream in a single time slice.

As an example, the traffic feature sequence may be a sequence in which traffic features corresponding to the same interaction operation in different historical time slices are arranged in chronological order. Such a traffic feature sequence may indicate the historical traffic changes of the corresponding interaction operation in the plurality of historical time slices of the live stream, thereby reflecting the traffic efficiency changes of the live stream in the plurality of historical time slices. For the convenience of discussion, a plurality of traffic changes (including historical traffic changes and predicted traffic changes) corresponding to the plurality of interaction operations are collectively or individually referred to as interaction traffic changes below.

As an example, assuming that the (t-3)th, (t-2)th and (t-1)th time slices in the live stream are historical time slices, the traffic feature sequence S_{comment} corresponding to the comment operation determined based on the (t-3)th, (t-2)th and (t-1)th time slices may be expressed as:

$${S}_{c o m m e n t} = [ … , {ε}_{t - 3} , {ε}_{t - 2} , {ε}_{t - 1} ] ; \qquad ( 1 )$$

where t is a positive integer, and εₜ₋₃ represents the traffic feature (for example, the number of comments) corresponding to the comment operation determined based on the (t-3)th historical time slice, εₜ₋₂ represents the traffic feature corresponding to the comment operation determined based on the (t-2)th historical time slice, and εₜ₋₁ represents the traffic feature corresponding to the comment operation determined based on the (t-1)th historical time slice.

In this way, the embodiments of the present disclosure can construct a highly timely traffic feature sequence from the perspective of the live streaming room by aggregating real-time interaction operations of the live streaming room based on minute-level (or finer-grained) time slices. In some embodiments, the length and number of the traffic feature sequences may be determined according to actual needs, which is not limited in the embodiments of the present disclosure. As an example, the length of the traffic feature sequence may be set to 15, the number of the traffic feature sequences may be set to 16, and so on.

At a block 220, the content recommendation system 150 determines, at least based on the plurality of traffic feature sequences, predicted traffic changes of the live stream respectively corresponding to the plurality of interaction operations in a target time slice.

As an example, the target time slice may be a time slice of the live stream at the current moment and/or a period of time after the current moment. As described above, the traffic efficiency changes of the live stream in the plurality of historical time slices may be reflected through the plurality of traffic feature sequences. By determining the predicted traffic change of the target time slice, the trend of the traffic efficiency of the live stream in the current time slice or one or more future time slices may be evaluated.

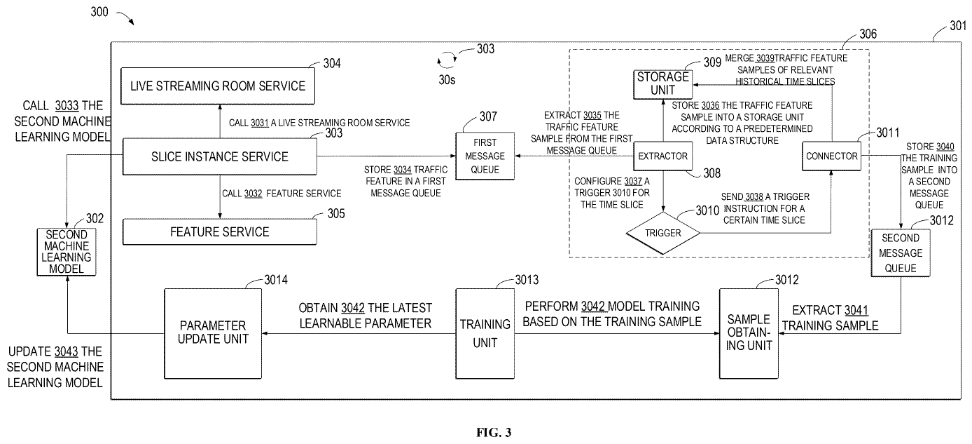

FIG. 3 shows a schematic diagram of an example architecture 300 of the content recommendation system 150 according to some embodiments of the present disclosure. Referring to FIG. 3, in some embodiments, the content recommendation system 150 generally includes a live streaming processing module 301 and a second machine learning model 302. The live streaming processing module 301 may process the live stream in the form of data stream and provide the traffic feature sequence as input data to the second machine learning model 302. In the embodiments of the present disclosure, the live streaming processing module 301 may also be referred to as a data stream engine (SelfFlow). As an example, the live streaming processing module 301 may trigger a slice instance service 303 based on a first predetermined period 303 (for example, 30 seconds or any other appropriate time). The slice instance service 303 may obtain the room identification of one or more live streaming rooms and their basic configuration files. For example, the slice instance service 303 may determine the traffic feature by calling (3031) a live streaming room service 304. Next, the slice instance service 303 may determine, with a time slice as the granularity, the traffic feature of each live streaming room based on the obtained room identification of the live streaming room and the basic configuration file thereof. For example, the slice instance service 303 may determine the traffic feature by calling (3032) a feature service 305. Next, the slice instance service 303 may construct a plurality of traffic feature sequences based on the determined traffic features. Then, the slice instance service 303 determines, at least based on the plurality of traffic feature sequences, the predicted traffic changes respectively corresponding to the plurality of interaction operations by calling (3033) the second machine learning model 302. As an example, the slice instance service 303 may call the second machine learning model 302 based on a second predetermined period (for example, 10 seconds or any other appropriate time) to determine the predicted traffic changes.

As an example, assuming that the target time slice is the t-th time slice and its x-1 future time slices, and the plurality of historical time slices is x time slices before the t-th time slice, the process of determining the predicted traffic changes by the second machine learning model 302 may be expressed by Equation (2), where x is a positive integer, and x may be set according to actual needs.

$${\hat{y}}_{t}^{c m t} , {\hat{y}}_{t}^{flw} , {\hat{y}}_{t}^{like} = F ( θ , Z ) ; \qquad ( 2 )$$

$$where {\hat{y}}_{t}^{c m t} , {\hat{y}}_{t}^{f l w} , {\hat{y}}_{t}^{like}$$

respectively represent the predicted traffic changes corresponding to the comment operation, the follow operation and the like operation in the target time slice, F(⋅) represents the algorithm executed by the second machine learning model 302, θ represents the learnable parameter of the second machine learning model 302, Z represents the input data of the second machine learning model 302, and the input data Z at least includes a plurality of traffic feature sequences determined based on the x time slices before the t-th time slice. It should be noted that the above algorithms and parameters for predicting traffic changes are only examples, and other algorithms and parameters may be used to determine the predicted traffic changes according to actual needs.

As an example, the predicted traffic changes

$${\hat{y}}_{t}^{c m t} , {\hat{y}}_{t}^{flw} , {\hat{y}}_{t}^{like}$$

may indicate whether the interaction traffic corresponding to the comment operation, the follow operation and the like operation will be increased in the target time slice compared with the plurality of historical time slices. As an example, the predicted traffic changes

$${\hat{y}}_{t}^{c m t} , {\hat{y}}_{t}^{flw} , {\hat{y}}_{t}^{like}$$

may be represented in the form of binary classification, for example, the predicted traffic changes

$${\hat{y}}_{t}^{c m t} , {\hat{y}}_{t}^{flw} , {\hat{y}}_{t}^{like} ∈ \{ 0 , 1 \} ,$$

where “0” indicates that the interaction traffic of the corresponding interaction operation is going to decline, and “1” indicates that the interaction traffic of the corresponding interaction operation is going to increase. In addition, the predicted traffic changes

$${\hat{y}}_{t}^{c m t} , {\hat{y}}_{t}^{flw} , {\hat{y}}_{t}^{like}$$

may also be represented in the form of probability, which is not limited in the embodiments of the present disclosure.

Continuing to refer to FIG. 3, in some embodiments, the second machine learning model 302 may be an online machine learning model, and the live streaming processing module 301 may construct traffic feature sequence samples based on an attribution unit 306 (this process may also be referred to as traffic change attribution), and then update the learnable parameter θ of the second machine learning model 302 online through model training.

Specifically, after determining the traffic feature, the slice instance service 303 may store the determined traffic feature as a traffic feature sample (which may also be referred to as a traffic feature instance) of the corresponding historical time slice. Then, in response to the trigger associated with a given historical time slice being triggered, the attribution unit 306 may construct a traffic feature sequence sample based on the given historical time slice and traffic feature samples of several historical time slices adjacent to the given historical time slice. In addition, the attribution unit 306 may also determine traffic change labels corresponding to the plurality of interaction operations, respectively, of the given historical time slice based on the given historical time slice and the traffic feature samples of the several historical time slices adjacent to the given historical time slice. Next, the livestreaming processing module 301 may update the learnable parameter θ of the second machine learning model 302 through model training at least based on the traffic feature sequence sample and the traffic change labels. The traffic change label of the given historical time slice indicates the traffic change of the given historical time slice and several historical time slices located after the given historical time slice with respect to the historical time slices located before the given historical time slice in the corresponding interaction operation.

As an example, the slice instance service 303 may store (3034) the determined traffic feature in a first message queue 307. The attribution unit 306 may use an extractor 308 or the like to extract (3035) the traffic feature sample from the first message queue 307. Then, the extractor 308 may store (3036) the traffic feature sample into a storage unit 309 according to a predetermined data structure, and the storage unit 309 may be, for example, a cache unit. As an example, the predetermined data structure of the traffic feature sample may be a key-value structure, the key in the key-value structure may be the room identification of the live streaming room to which the traffic feature belongs, and the value may be the slice identification of the time slice to which the traffic feature belongs in a time slice list. As an example, the time slices in the time slice list may be arranged in the chronological order of the time slices.

As an example, the attribution unit 306 may configure (3037) a trigger 3010 for the time slice of the live stream, and the trigger 3010 may send (3038) a trigger instruction for a certain time slice to a connector 3011 in the attribution unit 306, and the connector 3011 may, upon receiving the trigger instruction, construct a traffic feature sequence sample by merging (3039) traffic feature samples of relevant historical time slices (for example, several historical time slices adjacent to each other in the same live streaming room). Assuming that the given historical time slice is the t-th time slice, in the case where the t-th time slice is triggered, the connector 3011 may determine, based on the room identification, the historical time slices belonging to the same live streaming room as the t-th time slice, and based on the slice identification, further determine the t-th time slice and traffic feature samples of several historical time slices adjacent to the t-th time slice (for example, the (t−5)-th time slice to the (t−1)-th time slice and the (t+1)-th time slice to the (t+4)-th time slice). Then, the attribution unit 306 may construct a traffic feature sequence sample based on the determined traffic feature samples. In addition, the attribution unit 306 may delete an expired time slice in the time slice list (for example, it may be determined by a predetermined expiration time), thereby releasing the storage space of the time slice list.

As an example, assuming that the given historical time slice is the t-th time slice, and the several historical time slices adjacent to the given historical time slice are the (t−5)-th to (t−1)-th time slices and the (t+1)th to (t+4)-th time slices, respectively. Then, the traffic feature sample corresponding to the comment operation in the (t−5)-th to (t+4)-th time slices may be represented as

$${ε}_{i}^{c m t}$$

(for example, the comment rate), i=t−5, t−4, . . . , t+4. The traffic change label

$${y}_{t}^{c m t}$$

corresponding to the comment operation of the t-th time slice may be represented by Equation (3).

$${y}_{t}^{cmt} = \{ \begin{matrix}1 , & {\sum }_{i = t}^{t + 4} {ε}_{i}^{c m t} & > & {\sum }_{i = t ‐ 5}^{t ‐ 1} {ε}_{i}^{c m t} \\ 0 , & {\sum }_{i = t}^{t + 4} {ε}_{i}^{c m t} & \leq & {\sum }_{i ‐ t - 5}^{t ‐ 1} {ε}_{i}^{c m t}\end{matrix} \} ; \qquad ( 3 )$$

Based on a similar manner, the attribution unit 306 may also determine the traffic change label

$${y}_{t}^{f l w}$$

corresponding to the follow operation of the t-th time slice based on the traffic feature sample

$${ε}_{i}^{flw}$$

(for example, the follow rate) corresponding to the follow operation in the (t−5)-th to (t+4)-th time slices. In addition, the attribution unit 306 may also determine the traffic change label

$${y}_{t}^{like}$$

corresponding to the like operation of the t-th time slice based on the traffic feature sample

$${ε}_{i}^{like}$$

(for example, the like rate) corresponding to the like operation in the (t−5)-th to (t+4)-th time slices, and so on.

As an example, the traffic change labels

$${y}_{t}^{c m t} , {y}_{t}^{f l w} , {y}_{t}^{like}$$

indicate whether the interaction traffic corresponding to the interaction operation of the t-th to (t+4)-th time slices is improved compared with the (t-5)-th to (t−1)-th time slices. As an example, the traffic change labels

$${y}_{t}^{c m t} , {y}_{t}^{f l w} , {y}_{t}^{like}$$

may be represented in the form of binary classification or the form of probability, which may be determined according to actual needs, and is not limited in the embodiments of the present disclosure.

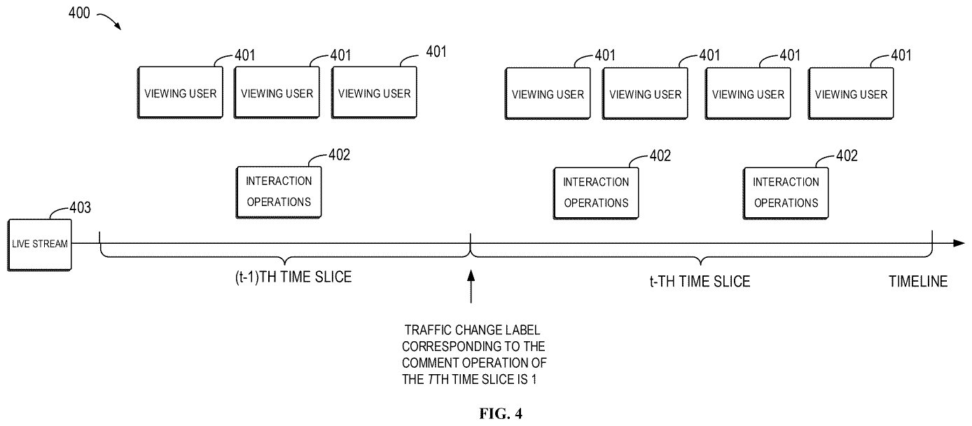

FIG. 4 shows a schematic diagram of an example 400 of determining a traffic change label according to some embodiments of the present disclosure. Referring to FIG. 4, the process of determining the traffic change label

$${y}_{t}^{c m t}$$

will be described below by taking the binary classification representation as an example. In the live stream 403, it is assumed that the given historical time slice is the t-th time slice, there is one and only one (t−1)-th time slice adjacent to the t-th time slice, and the traffic feature sample

$${ε}_{i}^{c m t}$$

indicates the comment rate in the corresponding time slice. In the (t−1)th time slice, assuming that there are three viewing users 401 and one interaction operation 402 (for example, a comment operation) of a certain type, the traffic feature sample

$${ε}_{t - 1}^{c m t}$$

corresponding to the comment operation is 1/3. Similarly, in the t-th time slice, assuming that there are four viewing users 401 and two interaction operations 402 (for example, comment operations) of the same type the traffic feature sample

$${ε}_{t}^{c m t}$$

corresponding to the comment operation is 2/4. Since

$${ε}_{t}^{c m t} > {ε}_{t - 1}^{c m t} ,$$

it may be considered that the comment rate of the livestream has increased, and then, it may be considered that the traffic change label

$${y}_{t}^{cmt}$$

corresponding to the comment operation of the t-th time slice is 1. Otherwise, it may be considered that the traffic change label

$${y}_{t}^{c m t}$$

corresponding to the comment operation of the t-th time slice is 0. And so on.

Referring back to FIG. 3, once the traffic feature samples are determined, the attribution unit 306 may construct a traffic feature sequence sample Fₜ based on these traffic feature samples. Then, the attribution unit 306 may construct a training sample

$${D}_{t} = \{ {F}_{t} , {Y}_{t}^{a c t i o n} \}$$

of the second machine learning model 302 based on the traffic feature sequence sample Fₜ and the traffic change label sample

$${Y}_{t}^{action} \cdot {F}_{t} = \{ {ε}_{i}^{cmt} , {ε}_{i}^{flw} , {ε}_{i}^{like} \} , {Y}_{t}^{action} = \{ {y}_{t}^{cmt} , {y}_{t}^{f l w} , {y}_{t}^{like} \} .$$

Then, the attribution unit 306 may store (3040) the training sample Dₜ into a second message queue 3012.

Next, the live streaming processing module 301 may update the learnable parameter θ in the second machine learning model 302 through model training based on the training sample in the second message queue 3012. As an example, a sample obtaining unit 3013 in the live streaming processing module 301 may extract (3041) the training sample Dₜ from the second message queue 3012. A training unit 3013 in the live streaming processing module 301 may perform model training based on the training sample Dₜ to determine the latest learnable parameter θ. Then, a parameter update unit 3014 in the live streaming processing module 301 obtains (3042) the latest learnable parameter θ, and then updates (3043) the second machine learning model 302 based on the obtained learnable parameter θ. As an example, the process of determining the predicted traffic changes

$${\hat{y}}_{t}^{′ cmt} , {\hat{y}}_{t}^{′ flw} , {\hat{y}}_{t}^{′ like}$$

by the second machine learning model 302 based on the training sample Dₜ may be expressed by Equation (4).

$${\hat{y}}_{t}^{′ cmt} , {\hat{y}}_{t}^{′ flw} , {\hat{y}}_{t}^{′ like} = F ( θ , {D}_{t} ) ; \qquad ( 4 )$$

In some embodiments, the second machine learning model 302 may be a multi-task learning model, and each task may correspond to a predicted traffic change of an interaction operation 402. Through the multi-task learning model, the embodiments of the present disclosure can share the feature extraction layer of the model to learn the common features between the plurality of tasks, thereby improving the overall learning efficiency and performance.

It should be noted that the above algorithms and parameters are only examples, which does not constitute a limitation on the embodiments of the present disclosure. According to actual needs, the embodiments of the present disclosure may adopt any appropriate algorithm and parameters, which will not be listed one by one here.

In some embodiments, the content recommendation system 150 may determine a dependency between each traffic feature in the plurality of traffic feature sequences and other traffic features except the traffic feature. Then, the content recommendation system 150 extracts a first feature representation of the plurality of traffic feature sequences based on the determined dependency. Then, the content recommendation system 150 determines, at least based on the first feature representation, the predicted traffic changes of the live stream 403 respectively corresponding to the plurality of interaction operations 402 in the target time slice.

As an example, the dependency between the plurality of traffic features may be the dependency between the plurality of traffic features in the same traffic feature sequence, or the dependency between the plurality of traffic features in different traffic feature sequences. The dependency between the plurality of traffic features may indicate the correlation between these traffic features. For example, when one type of traffic feature (for example, the comment rate of the comment operation) changes, another type of traffic feature (for example, the like rate of the like operation) also changes accordingly. By analyzing the dependency between these traffic features, the content recommendation system 150 may better understand the interaction between the plurality of traffic features, thereby providing an effective basis for subsequent traffic change prediction. As an example, the first feature representation may be a feature vector, a feature matrix, and/or an embedding representation generated through feature encoding. Through the first feature representation, the content recommendation system 150 may transform a complex traffic feature sequence into a concise and effective feature representation, thereby facilitating subsequent processing and analysis.

In some embodiments, the dependency between at least one traffic feature and other traffic features except the traffic feature at least includes a first dependency and/or a second dependency. The first dependency indicates the dependency between traffic features corresponding to different interaction operations 402 in the same historical time slice. The second dependency indicates the dependency between traffic features belonging to different historical time slices in the same traffic feature sequence.

As an example, in the same time slice of the live stream 403, the viewing user 401 may perform a plurality of interaction operations 402, such as a comment operation and/or a virtual gift giving operation. The first dependency may indicate the correlation between the traffic features (for example, the comment rate and/or the virtual gift giving rate, etc.) corresponding to these interaction operations 402 in the same time slice. For example, the comment rate may show a tendency to change with the virtual gift giving rate. In the embodiments of the present disclosure, the first dependency may also be referred to as the spatial dependency between the traffic features corresponding to the plurality of interaction operations 402. The first dependency helps the content recommendation system 150 to more accurately capture the association between different interaction operations 402 of the viewing user 401 in the same time slice.

As an example, a traffic feature (for example, the comment rate) corresponding to the same interaction operation 402 may have different performances in different time slices. For example, in the process of the live stream, the streamer performs different live streaming activities in different time slices, and the comment rate may show a tendency to change with the live streaming activities. In the embodiments of the present disclosure, the second dependency may also be referred to as the temporal dependency between the plurality of traffic features corresponding to the same interaction operation 402. The second dependency helps the content recommendation system 150 to more accurately capture the association between the same interaction operation 402 of the viewing user 401 in different time slices.

It should be noted that the above dependency between the traffic features is only an example. According to actual needs, the dependency between a traffic feature and other traffic features except the traffic feature may include more dependencies, which may be determined according to actual needs, and will not be listed one by one in the embodiments of the present disclosure.

In some embodiments, the content recommendation system 150 may extract, from the plurality of traffic feature sequences, a plurality of graph structure representations corresponding to a plurality of historical time slices of the live stream 403 based on the determined dependency, where for a given graph structure representation corresponding to a given historical time slice, nodes in the given graph structure representation correspond to traffic features belonging to the given historical time slice in the plurality of traffic feature sequences, and an edge between at least two nodes in the given graph structure representation is determined based on the dependency between the two corresponding traffic features. Then, the content recommendation system 150 may determine the first feature representation through feature encoding based on the dependency between the plurality of graph structure representations.

As an example, for each historical time slice, the content recommendation system 150 may generate a corresponding graph structure representation. In this graph structure, each node may correspond to one traffic feature, and the edges between the nodes represent the dependency between these traffic features. For example, if the traffic features of a certain time slice include the number of likes and/or the number of comments, etc., these traffic features will be used as nodes in the corresponding graph structure representation, and the dependency between them (such as the comment rate changes with the virtual gift giving rate) is represented by the edges. Such a graph structure representation may indicate the spatial dependency between the plurality of traffic features described above.

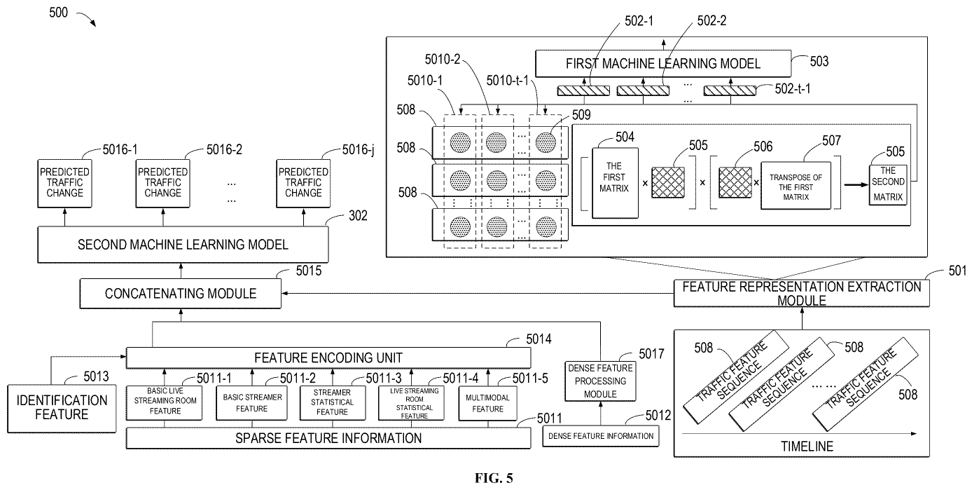

FIG. 5 shows a schematic diagram of an example 500 of determining predicted traffic changes according to some embodiments of the present disclosure. FIG. 5 shows a plurality of traffic feature sequences 508, different traffic feature sequences correspond to different interaction operations, for example, the plurality of traffic feature sequences 508 shown in FIG. 5 correspond to a comment operation, a like operation, a virtual gift giving operation, and the like, respectively. FIG. 5 also shows a plurality of blocks 5010-1, 5010-2, . . . , 5010-t-1. Assuming that the plurality of historical time slices are the first time slice to the (t−1)th time slice, the traffic feature 509 shown in the block 5010-1 may be the traffic feature 509 determined based on the first time slice, the traffic feature 509 shown in the block 5010-2 may be the traffic feature 509 determined based on the second time slice, and the traffic feature 509 shown in the block 5010-t-1 may be the traffic feature 509 determined based on the (t−1)th time slice, and so on.

The content recommendation system 150 may use a feature representation extraction module 501 to determine a plurality of graph structure representations 502-1, 502-2, . . . , 502-t-1 corresponding to the plurality of historical time slices by means of graph embedding and/or a graph neural network (GNN), etc. For the convenience of discussion, the plurality of graph structure representations 502-1, 502-2, . . . , 502-t-1 are collectively or individually referred to as graph structure representations 502 below. As an example, assuming that the plurality of historical time slices are the first time slice to the (t−1)th time slice, the graph structure representation 502-1 is a graph structure representation 502 corresponding to the first time slice, the graph structure representation 502-2 is a graph structure representation 502 corresponding to the second time slice, and the graph structure representation 502-t-1 is a graph structure representation 502 corresponding to the (t−1)th time slice. The graph embedding may use a low-dimensional vector space to enable similar nodes in the graph structure representation 502 to be closer in distance in the vector space. The graph neural network may predict unknown information in the graph by learning the features of the nodes and edges in the graph structure representation 502.

Next, the feature representation extraction module 501 may use a first machine learning model 503 (for example, a transformer model) to identify the dependency between the plurality of graph structure representations 502, and perform feature encoding to determine the first feature representation. The first feature representation may simultaneously indicate the temporal dependency and the spatial dependency between the plurality of traffic features described above. In the embodiments of the present disclosure, the feature representation extraction module 501 may also be referred to as a spatio-temporal fusion module.

In this way, the content recommendation system 150 can use the feature representation extraction module 501 to model the interaction traffic change trend of the interaction operation 402 in the historical time slices with a time slice as the granularity, thereby deeply mining the potential spatio-temporal dependency between the plurality of traffic features based on the perspective of the live streaming room.

In some embodiments, the plurality of graph structure representations 502 are extracted from the plurality of traffic feature sequences at least by the graph diffusion convolution. In some embodiments, the dependency between the plurality of graph structure representations 502 is determined at least by the first machine learning model with the multi-head attention mechanism.

Continuing to refer to FIG. 5, the feature representation extraction module 501 may process the plurality of traffic feature sequences 508 into a first matrix 504 (which may also be other forms) of a non-Euclidean structure, and the first matrix 504 may also be represented as a matrix X, X∈R^{N×T}, where R represents a real number, N represents the number of traffic feature sequences 508, and T represents the length of the traffic feature sequences 508. As an example, the feature representation extraction module 501 may determine a second matrix 505 based on the first matrix 504, a first learnable parameter 506, a second learnable parameter 507 and a transpose 507 of the first matrix 504, and the second matrix 505 may also be represented as an adaptive attention matrix Ãₐₜₜ, Ãₐₜₜ∈R^{N×N}. Then, the feature representation extraction module 501 uses the graph diffusion convolution to extract the spatial dependency between the plurality of traffic features 509 from the second matrix 505, thereby obtaining the plurality of graph structure representations 502. As an example, the second matrix 505 (that is, the adaptive attention matrix Ãₐₜₜ) may be represented by Equation (5).

$${\tilde{A}}_{a t t} = SoftMax ( Relu ( ( {XT}_{w 1} ) {( {XT}_{w 2} )}^{T} ) ; \qquad ( 5 )$$

where T_{w1} and T_{w2} represent the first learnable parameter 506 and the second learnable parameter 507, respectively, T_{w1}∈R^{T×T}, T_{w2}∈R^{T×T}. SoftMax(Relu((XT_{w1})(XT_{w2})^{T}) represents the normalization of (Relu((XT_{w1})(XT_{w2})^{T}), Relu((XT_{w1})(XT_{w2})^{T} represents the elimination of some connections with weaker correlations using ReLU matrix factorization, and (⋅)^{T} represents the transpose. As an example, T_{w1} and T_{w2} represent the embedding of the source node and the target node in the graph structure representation 502, respectively.

In some embodiments, the feature representation extraction module 501 may regard the adaptive attention matrix Ãₐₜₜ as the transition matrix Aₐₜₜ of the implicit diffusion process, and the output Dₐₜₜ(X⁽ⁱ⁾, Aₐₜₜ) of the graph attention layer of the ith time slice in the graph diffusion convolution may be represented by Equation (6).

$${D}_{a t t} ( {X}^{( i )} , {A}_{a t t} ) = ( {D}_{O}^{- 1} {A}_{a t t} ) {X}^{( i )} {W}_{k 1} + ( {D}_{I}^{- 1} {A}_{att}^{T} ) {X}^{( i )} {W}_{k 2} ; \qquad ( 6 )$$

where D_{O}=diag(Aₐₜₜ), D_{I}=diag(Aₐₜₜ^{T}),

$${D}_{O}^{1} {A}_{att} and {D}_{I}^{- 1} {A}_{a t t}^{T}$$

represent the transition matrices of the bidirectional diffusion process, respectively, Wₖ₁ and Wₖ₂ are learnable parameters, Wₖ₁∈R^{1×dk}, Wₖ₂∈R^{1×dk}, dk represents the first embedding dimension, and diag(⋅) represents the diagonal operation. After the spatial dependency between the plurality of traffic features 509 is extracted through the graph attention layer Dₐₜₜ(X⁽ⁱ⁾, Aₐₜₜ), the graph structure representation 502 corresponding to each historical time slice may be obtained, and the graph structure representation 502 may also be represented as Hⁱ, Hⁱ∈R^{N×dk}. In essence, the graph structure representation 502 implicitly learns the spatial dependency between the plurality of traffic features 509 by aggregating neighbor nodes at each hop on the graph.

In addition to the spatial dependency between the plurality of traffic features 509, each traffic feature sequence 508 also contains a temporal dependency. This temporal dependency not only shows a contextual relationship, but also has a global impact. In the embodiments of the present disclosure, the feature representation extraction module 501 may extract the temporal dependency (or may also be referred to as the global temporal dependency) between the plurality of traffic features 509 based on the first machine learning model 503 with the multi-head attention mechanism. As an example, the first machine learning model 503 may be any appropriate model, including but not limited to a transformer model, etc.

As an example, the feature representation extraction module 501 may connect the graph structure representations Hⁱ corresponding to all historical time slices to obtain the graph structure representation H_{f}∈R^{B×N×T×dk}, where B is the batch size. Next, the feature representation extraction module 501 flattens the first two dimensions of the graph structure representation H_{f} to obtain the graph structure representation E_{f}∈R^{BN×T×dk}. Then, the feature representation extraction module 501 uses a plurality of (for example, three) transformation matrices to linearly project the flattened graph structure representation E_{f} to obtain matrices Q, K and V, which represent the query feature, the key feature and the value feature, respectively.

As an example, the output Aₐₜₜ(Q, K, V) of the self-attention layer of the first machine learning model 503 may be represented by Equation (7).

$${A}_{a t t} ( Q , K , V ) = SoftMax ( \frac{Q {K}^{T}}{\sqrt{{d}_{w}}} ) V ; \qquad ( 7 )$$

where Q, K, V∈R^{BN×T×dw}, and dw represents the second embedding dimension. In order to enhance the expression ability, the first machine learning model 503 has a multi-head attention mechanism to extract the temporal dependency between the plurality of traffic features 509 in the plurality of subspaces.

As an example, the output MultiAtt(Q, K, V) of the multi-head attention mechanism may be expressed by Equation (8) and Equation (9).

$$MultiAtt ( Q , K , V ) - Concat ( {head}_{1} , {head}_{1} , … , {head}_{1} ) ; \qquad ( 8 )$$

$${head}_{1} = {A}_{a t t} ( {E}_{f} {Θ}^{Q} , {E}_{f} {Θ}^{K} , {E}_{f} {Θ}^{V} ) ; \qquad ( 9 )$$

where n is the number of attention heads, Θ^{Q}, Θ^{K}, Θ^{V} is projection matrix, Θ^{Q}, Θ^{K}, Θ^{V}∈R^{dk×dw}.

Next, the feature representation extraction module 501 may input the output MultiAtt(Q, K, V) of the multi-head attention output multi-head attention mechanism into the feed-forward network with residual connection to obtain the first feature representation E_{seq}, E_{seq}∈R^{B×NT×demb}, and demb represents the third embedding dimension. In this way, the embodiments of the present disclosure learn the hidden spatio-temporal dependency between the plurality of traffic features 509 through the graph diffusion convolution and the multi-head attention mechanism.

It should be noted that the above algorithms and parameters are only examples, and do not constitute a limitation on the embodiments of the present disclosure. According to actual needs, the embodiments of the present disclosure may adopt any appropriate algorithm and parameters, which will not be listed one by one here.

In some embodiments, the content recommendation system 150 may determine the predicted traffic changes of the live stream 403 respectively corresponding to the plurality of interaction operations 402 in the target time slice using the second machine learning model 302 based on the plurality of traffic feature sequences 508 and sparse feature information 5011 related to the live stream 403. Alternatively or additionally, the content recommendation system 150 may determine the predicted traffic changes e of the live stream 403 respectively corresponding to the plurality of interaction operations 402 in the target time slice using the second machine learning model 302 based on the plurality of traffic feature sequences 508 and dense feature information 5012 related to the live stream 403 and/or the plurality of interaction operations 402. In other words, the input of the second machine learning model 302 may include the above sparse feature information 5011 and/or dense feature information 5012 in addition to the plurality of traffic feature sequences 508.

Continuing to refer to FIG. 5, FIG. 5 shows a plurality of predicted traffic changes 5016-1, 5016-2, . . . , 5016-j, where j is a positive integer. For the convenience of discussion, the plurality of predicted traffic changes 5016-1, 5016-2, . . . , 5016-j are also collectively or individually referred to as predicted traffic changes 5016 below. As an example, the plurality of predicted traffic changes 5016-1, 5016-2, . . . , 5016-j shown in FIG. 5 may be predicted traffic changes 5016 corresponding to the comment operation, the like operation and the virtual gift giving operation, respectively.

As an example, the sparse features may be those features that appear discontinuously in the dataset and most of the values are zero. As an example, the sparse feature information 5011 may include the basic live streaming room feature 5011-1 of the live streaming room to which the live stream 403 belongs, the basic streamer feature 5011-2 of the streamer to which the live stream 403 belongs, the streamer statistical feature 5011-3 associated with the streamer in the live stream 403, the live streaming room statistical feature 5011-4 associated with the live streaming room, and so on. As an example, the basic live streaming room feature includes, but is not limited to, a live streaming room type, a live streaming room label, a live streaming area, etc. The basic streamer feature may include a streamer type, a streamer label, etc. The live streaming room statistical feature 5011-4 may include the cumulative number and/or the average number of one or more interaction operations 402 initiated by the viewing user 401 in a predetermined number of time slices. The predetermined number here may be set according to actual needs, for example, the predetermined number may be set to 1, 3, 5, 10, 15, etc.

The live streaming room statistical feature 5011-4 may also include the cumulative number and/or the average number of one or more interaction operations 402 initiated by the viewing user 401 in the live streaming room within a predetermined period of time in the past. Alternatively or additionally, the streamer statistical feature 5011-3 may also include the average live streaming duration and/or the number of live streaming days of the streamer within a predetermined period of time in the past. The predetermined period of time may be set according to actual needs, for example, the predetermined period of time may be set to 1, 7, 14 days, etc.

As an example, the dense features may be those features that appear frequently in the dataset. In the embodiments of the present disclosure, the dense feature information 5012 may include, for example, a statistical feature with finer granularity, etc., for example, the dense feature information 5012 includes a statistical feature for the traffic feature sequence 508 (for example, the number of likes, the like rate, the number of comments, etc. in the last several time slices). In addition, the dense feature information 5012 may also include statistical features such as the cumulative number and/or the average number of the interaction operations 402 collected with a finer time window.

As an example, the sparse feature information 5011 may also include a multimodal feature 5011-5. The multimodal feature 5011-5 may include, for example, an image feature and a text feature, etc. The multimodal feature 5011-5 may be acquired by means of automatic speech recognition (ASR) and/or optical character recognition (OCR), etc. As an example, the content recommendation system 150 may encode the result of the automatic speech recognition and/or the result of the optical character recognition to generate an image feature representation and a text feature representation. In some embodiments, the content recommendation system 150 may align the image feature representation and the text feature representation of the same live streaming room based on a segment-based contrastive learning method, thereby enhancing the multimodal representation effect. The content recommendation system 150 may also refine the representations of different live stream 403 that are of interest to the same viewing user 401, and so on. After obtaining the image feature representation and the text feature representation, the content recommendation system 150 may use a deep clustering algorithm to generate the hierarchical multimodal feature 5011-5. As an example, the multimodal feature 5011-5 may be updated based on a predetermined period. The update of the predetermined period may be determined based on the length of the time slice to capture the real-time content change of the live stream 403.

As an example, the content recommendation system 150 may use the feature encoding unit 5014 to convert the identification feature 5013 (for example, the streamer identification of the streamer to which the live stream 403 belongs and the slice identification of the time slice to which the sparse feature information 5011 belongs) and the sparse feature information 5011 into a unified low-dimensional dense feature representation, and then concatenate the converted low-dimensional dense feature representation. Therefore, it is convenient for the second machine learning model 302 to learn personalized interaction traffic change patterns of different time slices (and/or different streamers).

As an example, the content recommendation system 150 may use the dense feature processing module 5017 to process the dense feature information 5012 to obtain a better feature representation. For example, the dense feature processing module 5017 may include, but is not limited to, a deep neural network (Deep Neural Networks, DNN), etc. Then, the content recommendation system 150 may use the concatenating module 5015 to concatenate the output of the feature encoding unit 5014, the output of the dense feature processing module 5017 and the output of the feature representation extraction module 501 to obtain the concatenated result E, and the concatenated result Eᵥ may be expressed as Eᵥ=[E_{basic}, Eₛₜₐₜ, E_{seq}, Eₘₘ, E_{id}], where E_{basic}, Eₛₜₐₜ, E_{seq}, Eₘₘ, E_{id} represent the dense feature representations determined based on the basic features (for example, the basic live streaming room feature 5011-1 and the basic streamer feature 5011-2, etc.), the statistical features (for example, the live streaming room statistical feature 5011-4, the streamer statistical feature 5011-3, and the statistical features involved in the dense feature information 5012, etc.), the traffic feature sequence 508 and the identification feature 5013, respectively.

Subsequently, the content recommendation system 150 may perform high-order feature crossing on the concatenated result Eᵥ based on a feature crossing network, and then use the second machine learning model 302 (for example, a multi-task learning model) based on a feature sharing mechanism to determine the predicted traffic changes 5016 corresponding to the plurality of interaction operations 402, respectively. As an example, the content recommendation system 150 may implement feature crossing based on a deep neural network (DNN). In addition, in some embodiments, the feature sharing component in the multi-task learning model may also be replaced by other networks (such as DCN-V2 or XDeepFM, etc.). As an example, the main task of the second machine learning model 302 is to maximize the likelihood probability between the predicted value and the actual value, therefore, the embodiments of the present disclosure may train the second machine learning model 302 through a standard cross-entropy loss function [symbol] . As an example, the loss function £ may be expressed by Equation (10).

$$ℒ = - {\sum }_{∀ j ∈ a c t} {\sum }_{i = 1}^{n} ( {y}_{i}^{j} log ( {\hat{y}}_{i}^{j} ) + ( 1 - {y}_{i}^{j} ) log ( 1 - {\hat{y}}_{i}^{j} ) ) + γ {‖ Θ ‖}_{2}^{2} ; \qquad ( 10 )$$

where Θ represents the learnable parameter of the second machine learning model 302,

$${y}_{i}^{j} and {\hat{y}}_{i}^{j}$$

represent the predicted traffic change 5016 and the actual traffic change of the jth interaction operation 402 of the ith time slice, respectively,

$$γ {‖ Θ ‖}_{2}^{2}$$

represents the L2 regularization term, and γ represents the hyperparameter used for balancing.

In this way, the embodiments of the present disclosure use the feature representation extraction module 501 to perform feature encoding on the traffic feature sequence 508. Then, after converting all sparse feature representations into dense feature representations, DNN is used to perform high-order crossing on all dense feature representations. Finally, the embodiments of the present disclosure use the multi-task learning model with feature sharing ability to obtain the predicted traffic changes 5016 corresponding to the plurality of interaction operations 402, respectively. Therefore, the embodiments of the present disclosure can extract the potential spatio-temporal dependency between the plurality of traffic features 509. In addition, the embedding of the streamer identification and the time slice identification enables the second machine learning model 302 to learn the personalized information of the streamer and the time slice at the same time.

It should be noted that the above algorithms and parameters are only examples, and do not constitute a limitation on the embodiments of the present disclosure. According to actual needs, the embodiments of the present disclosure may adopt any appropriate algorithm and parameters, which will not be listed one by one here.

Once the predicted traffic changes 5016 of the live stream 403 respectively corresponding to the plurality of interaction operations 402 in the target time slice are determined, at block 230, the content recommendation system 150 determines a recommendation degree of the live stream 403 for a user group based on at least the predicted traffic changes 5016.

As an example, the content recommendation system 150 may divide the user group based on the viewing habits of the viewing users 401, etc. For example, the content recommendation system 150 may divide the viewing users 401 with similar interests into the same user group. From the perspective of the viewing user 401, the viewing user 401 focuses on the attractiveness of the live streaming content. Therefore, the content recommendation system 150 may determine the recommendation degree of the live stream 403 for the user group based on features such as the viewing habits of the user group and the predicted traffic changes 5016. As an example, the content recommendation system 150 may determine one or more candidate live stream for the user group based on features such as the viewing habits of the user group. Then, the content recommendation system 150 further adjusts the recommendation degrees of these live stream 403 based on the predicted traffic change 5016 of each candidate live stream, so as to change the recommendation priorities of these live stream 403. For example, the higher the predicted traffic, the more popular the live stream 403 will be in the future, therefore, the recommendation degree of the live stream 403 may be increased accordingly.

In some embodiments, the content recommendation system 150 may determine an adjustment recommendation score for the live stream 403 based on the predicted traffic changes 5016 respectively corresponding to the plurality of interaction operations 402, where the adjustment recommendation score indicates an overall traffic change of the live stream 403 corresponding to the plurality of interaction operations 402 in the target time slice. Then, the content recommendation system 150 may determine the recommendation degree of the live stream 403 for the user group (which may also be said to be the viewing user 401) based on a reference recommendation score of the live stream 403 for the user group and the adjustment recommendation score.

As an example, the adjustment recommendation score may be calculated in any appropriate way, such as weighted summation of the predicted traffic changes 5016, to ensure that the influence of the traffic changes of different interaction operations 402 on the final score is reasonable. The reference recommendation score may be determined based on factors such as the content quality of the live stream 403, the popularity of the streamer, and the historical viewing records of the viewing user 401. As an example, the recommendation degree here may be a specific numerical value or ranking, and the recommendation degree is used to indicate the recommendation priority of the live stream 403 in the user group.

By adjusting the recommendation score and the recommendation degree, the content recommendation system 150 may ensure that the streamer's live stream 403 gets enough exposure and interaction in a suitable time slice. This helps raise the streamer's popularity and earnings. At the same time, the content recommendation system 150 also considers the viewing experience and satisfaction of the viewing user 401. By recommending the live stream 403 that is of interest to the viewing user 401, the content recommendation system 150 may increase the user's viewing duration and interaction frequency. Therefore, the embodiments of the present disclosure achieve a virtuous cycle of the live streaming ecosystem by considering the bilateral experience of the streamer and the viewing user 401.

In some embodiments, the recommendation degree is positively related to the overall traffic change indicated by the adjustment recommendation score.

As an example, the recommendation degree Rₑₓₚ may be expressed by Equation (11) and Equation (12).

$${R}_{exp =} {R}_{b a s e} + {G}_{score} ; \qquad ( 11 )$$

$${G}_{score} = α 1 \times ( 1 + β 1 \times {\hat{y}}_{t}^{c m t} ) + α 2 \times ( 1 + β 2 \times {\hat{y}}_{t}^{f l w} ) + … + α n \times ( 1 + β n \times {\hat{y}}_{t}^{like} ) ; \qquad ( 12 )$$

where R_{base} represents the reference recommendation score for the user group, G_{score} represents the adjustment recommendation score, and α and β are hyperparameters used to combine all the predicted traffic changes 5016. In this way, from the perspective of the live streaming room, the embodiments of the present disclosure model the trend of interaction traffic changes (or traffic efficiency) with time slices as the granularity, providing an additional information gain factor for the recommendation of the live stream 403.

During the live stream, the streamer mainly focuses on the smoothness of the interaction traffic, the total number of traffic and the traffic performance. The content recommendation system 150 may allocate a certain amount of effective push traffic to the live stream 403 in a unit time slice through a proportional-integral-derivative control system (PID) based on an online service. The effective push traffic refers to the push traffic that can bring actual interaction and conversion value to the live stream 403. For the streamer, the effective push traffic means more audience participation and higher exposure. However, effective traffic resources are scarce, and the demand for effective push traffic varies in different stages of the live streaming process. In order to ensure that the streamer with improved live streaming quality can get a certain incentive of effective push traffic in time, the embodiments of the present disclosure may further adjust the allocation of effective push traffic in combination with the predicted traffic changes 5016.

In some embodiments, the content recommendation system 150 may adjust target push traffic associated with the live stream 403 in the target time slice based on the predicted traffic changes 5016 corresponding to the plurality of interaction operations 402, respectively. Then, the content recommendation system 150 may determine a traffic control score of the live stream 403 in the target time slice based on at least the adjusted target push traffic and consumed push traffic associated with the live stream 403. Then, the content recommendation system 150 may determine a ranking of the livestreaming 403 in a live streaming push sequence of the user group based on at least the traffic control score of the live stream 403 and the recommendation degree.

As an example, the target push traffic may refer to the effective push traffic that the content recommendation system 150 plans to allocate to the live stream 403 in a target time period. The consumed push traffic may refer to the effective push traffic that the content recommendation system 150 has provided to the live stream 403 by the current moment. As an example, the target push traffic and the consumed push traffic may be represented in the form of counting. For example, assuming that the content recommendation system 150 plans to provide “2” likes for the live stream 403, then the target push traffic may be recorded as “2”. Assuming that currently a user accesses the live stream 403 based on the effective push traffic and initiates a like operation in the live stream 403, then the consumed push traffic may be recorded as “1”. It should be noted that the above description about the counting of the target push traffic and the consumed push traffic is only example content, which does not constitute a limitation on the embodiments of the present disclosure. According to actual needs, the target push traffic and the consumed push traffic may also be counted in other ways.

As an example, with the recommendation degree unchanged, the traffic control score is positively related to the ranking of the live stream 403 in the live streaming push sequence of the user group, that is, the higher the traffic control score, the higher the ranking of the live stream 403 in the live streaming push sequence of the user group, and the lower the traffic control score, the lower the ranking of the live stream 403 in the live streaming push sequence of the user group.

As an example, the traffic control score is related to a difference between the target push traffic and the consumed push traffic. Specifically, with the consumed push traffic unchanged, the target push traffic is positively related to the traffic control score, that is, the greater the target push traffic, the greater the traffic control score, and the smaller the target push traffic, the lower the traffic control score. In the embodiments of the present disclosure, in the case that the predicted traffic change 5016 indicates that the interaction traffic of the live stream 403 is going to increase, the target push traffic (for example, increasing to “3” from “2”) may be increased to improve the traffic control score, thereby appropriately increasing the ranking of the live stream 403 in the live streaming push sequence of the user group. In other cases, the target push traffic may be made to gradually approach the initial value before adjustment (for example, returning to “2” from “3”), so that the traffic control score of the live stream 403 with stable or decreasing interaction traffic may be restored to the baseline level.

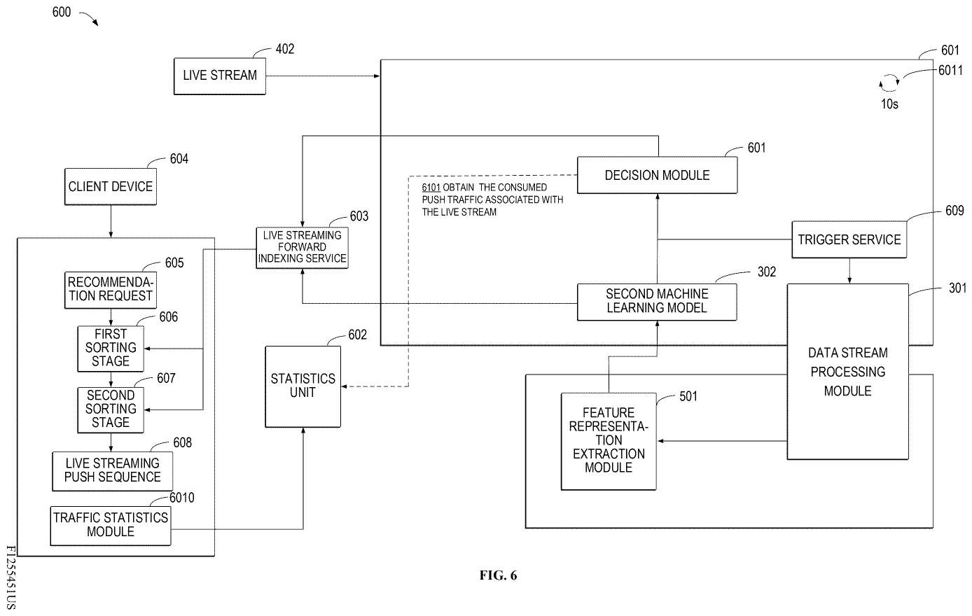

FIG. 6 shows a schematic diagram of an example 600 of adjusting a recommendation ranking according to some embodiments of the present disclosure. Referring to FIG. 6, the content recommendation system 150 further includes a decision module 601. The decision module 601 is used to adjust the traffic control score to enhance the streamer's live streaming experience. The decision module 601 may trigger a related service (for example, a statistics service 602) in real time or periodically to obtain (6101) the consumed push traffic (which may also be referred to as a consumed push traffic count) associated with the live stream 403. Then, the decision module 601 obtains an error signal by subtracting the consumed push traffic count from the set target push traffic (which may also be referred to as a target push traffic count). Then, the traffic control score is determined based on the error signal.

As an example, the adjustment process of the traffic control score p may be expressed by Equation (13) to Equation (15).

$$intergal = {α}_{I} {\sum }_{t = 1}^{n} ( {N}_{t a r g e t} - {N}_{impr} ) \times {e}^{{α}_{decay} ( t - n )} ; \qquad ( 13 )$$

$$lagboost = t / {t}_{target} - {\sum }_{t = 1}^{n} {N}_{impr} / {N}_{target} ; \qquad ( 14 )$$

$${μ}_{p} = intergal + lagboost ; \qquad ( 15 )$$

where N_{target}-Nᵢₘₚᵣ represents the error signal, N_{target} represents the target push traffic, Nᵢₘₚᵣ represents the consumed push traffic, represents the current historical time slice, α_{I}, α_{decay}, t_{target} are a first predetermined coefficient, a second predetermined coefficient and a third predetermined coefficient, respectively, related to the traffic control score regulation, and n represents a window size, that is, n historical time slices.

In some embodiments, the content recommendation system 150 may determine an adjustment recommendation score for the live stream 403 based on the predicted traffic changes 5016 respectively corresponding to the plurality of interaction operations 402, where the adjustment recommendation score indicates an overall traffic change of the live stream 403 corresponding to the plurality of interaction operations 402 in the target time slice. Then, in response to the adjustment recommendation score indicating that the overall traffic of the live stream 403 corresponding to the plurality of interaction operations 402 in the target time slice is going to increase, the content recommendation system 150 may increase the target push traffic by a first value. Alternatively or additionally, in response to the adjustment recommendation score indicating that the overall traffic corresponding to the plurality of interaction operations 402 in the target time slice of the live stream 403 is going to decrease, the content recommendation system 150 may reduce the target push traffic by a second value.

As an example, the content recommendation system 150 may dynamically adjust the target push traffic based on the predicted traffic changes 5016. This design aims to enable the content recommendation system 150 to enable the live stream 403 to obtain more effective push traffic in time when the predicted traffic of the live stream 403 is going to increase. When the predicted traffic of the live stream 403 is going to decline, the content recommendation system 150 reduces the effective push traffic. When the predicted traffic of the live stream 403 is in a stable state, the content recommendation system 150 ensures that the target push traffic N target may quickly converge to the baseline level. Therefore, the dynamic allocation of effective push traffic in the spatio-temporal domain may be achieved.

The process of adjusting the target push traffic in the embodiments of the present disclosure will be described below.

Continuing with Equation (13) to Equation (15) above. First, initialize the following parameters related to the adjustment process of the target push traffic: R⁻=0, R⁺=0, S_{dura}=∞, Sₛₜ=0, N⁺=0, N⁻=0, where R⁻ represents that the predicted traffic change 5016 of the time slice t is going to decline, R⁺ represents that the predicted traffic change 5016 of the time slice t is going to rise, S_{dura} represents the predicted traffic rise/decline state duration, Sₛₜ represents the predicted traffic rise/decline state start time, N⁺ represents the count of R⁺, N⁻ represents the count of R⁻. It should be noted that R⁺, R⁻ is unique in each time slice.

Then, let t be 1, 2, . . . , T in turn, and calculate the value of the target push traffic each time t gets a value, where T is the total number of time slices. As an example, each time t gets a value, the calculation process of the target push traffic may be expressed based on Equation (16) to Equation (23).

$${S}_{d u r a} = t - {S}_{s t} ; \qquad ( 16 )$$

$$If {S}_{d u r a} > {T}_{g a p} \& {G}_{s c o r e} \geq {g}^{+} , then {R}^{+} = 1 , {S}_{s t} = t , {N}^{+} + 1 ; \qquad ( 17 )$$

$$If {S}_{d u r a} > {T}_{g a p} \& {G}_{s c o r e} \leq {g}^{-} , then {R}^{-} = 1 , {S}_{s t} = t , {N}^{-} + 1 ; \qquad ( 18 )$$

$$If {S}_{d u r a} \leq {T}_{g a p} or {g}^{-} < {G}_{s c o r e} < {g}^{+} , then {R}^{+} = {R}^{-} = 0 , {S}_{s t} = 0 ; \qquad ( 19 )$$

$$Δ mpc = {R}^{+} - {R}^{-} ; \qquad ( 20 )$$

$$δ t = ( t - {S}_{s t} ) ; \qquad ( 21 )$$

$${T}_{d e c a y =} {e}^{{t}_{d e c a y} \times δ t / 3 \; 600} ; \qquad ( 22 )$$

$${N}_{t a r g e t} = {N}_{t a r g e t} + {Γ}_{i m p r} \times Δ mpc \times {T}_{d e c a y} ; \qquad ( 23 )$$

where Γᵢₘₚᵣ×Δmpc×T_{decay} is the first value by which the target push traffic is increased or the second value by which the target push traffic is decreased, T_{gap}, T_{decay}, Γᵢₘₚᵣ represent error signal correction hyperparameters, g+ and g− represent an upper threshold limit and a lower threshold limit, respectively, of the adjustment recommendation score G_{score}, and g+ and g− may be set according to a precision-recall threshold.

Once the adjusted target push traffic and the consumed push traffic are determined, the decision module 601 may calculate the outputs of the proportional term and the integral term through the PID system. Then, the decision module 601 sends the output (for example, the traffic control score) of the PID system to a live streaming forward indexing service 603. A client device 604 of the user group may send a recommendation request 605 to the content recommendation system 150 in real time or periodically. The live streaming forward indexing service 603 in the content recommendation system 150 may determine the livestreaming 403 to be recommended to the user group through a plurality of sorting stages. As an example, the live streaming forward indexing service 603 may determine the live stream 403 (that is, the live streaming push sequence 608) to be recommended to the user group through at least a first sorting stage 606 (which may also be referred to as a coarse sorting stage) and a second sorting stage 607 (which may also be referred to as a fine sorting stage) executed based on the sorting result of the first sorting stage 606. As an example, at each sorting stage, the live streaming forward indexing service 603 may determine the ranking of the live stream 403 at the sorting stage based on the recommendation degree of the live stream 403 (determined based on the plurality of predicted traffic changes output by the second machine learning model) and/or the traffic control score output by the decision module 601.

In this way, the embodiments of the present disclosure can take into account the bilateral experience of both the viewing user 401 and the streamer. It is ensured that when the streamer's live streaming performance improves, the streamer may get the incentive of high-quality effective traffic. At the same time, the viewing user 401 may watch more high-quality live streaming content, and the effect of live streaming recommendation may be improved through the joint optimization of the bilateral experience.

In some embodiments, a trigger service 609 in the content recommendation system 150 may trigger the feature service 305 to generate traffic features based on a third predetermined periodicity 6011 (for example, 10 seconds or other appropriate time), and determine the predicted traffic changes 5016 by means of the second machine learning model 302. Alternatively or additionally, the trigger service 609 may also trigger the decision module 601 based on the third predetermined periodicity 6011 to determine the traffic control score.

In some embodiments, after the viewing user 401 accesses the live stream 403 based on the live streaming push sequence 608, the traffic statistics module 6010 may update the information such as the count of the consumed push traffic in the statistics unit 602 and the current interaction traffic of the live stream 403 based on the interaction operation taken by the viewing user 401 in the live stream 403. In this way, the content recommendation system 150 may continuously collect the interaction traffic changes that occur in real time in the live stream 403, so that the learnable parameters of the second machine learning model 302 may be updated in real time, and the second machine learning model 302 may be ensured to adapt to the new traffic distribution.

It may be clearly understood from the embodiments described above that the embodiments of the present disclosure construct a data stream processing module 301 (which may also be referred to as a data stream engine), and the data stream processing module 301 may support interaction traffic change attribution at the granularity of a time slice from the perspective of a live streaming room. At the same time, the embodiments of the present disclosure further propose a feature extraction module 501 (also referred to as a spatio-temporal fusion module) to capture the dynamic trend of the interaction traffic change. The feature extraction module 501 uses rich basic features, statistical features, traffic feature sequences 508, etc. to mine the potential spatio-temporal dependency between the plurality of interaction operations 402. Finally, the embodiments of the present disclosure use the decision module 601 to integrate the traffic prediction result into the online recommendation process of the live stream 403, thereby balancing the benefits of the consumption side and the supply side from the bilateral perspective of the streamer and the viewing user 401.

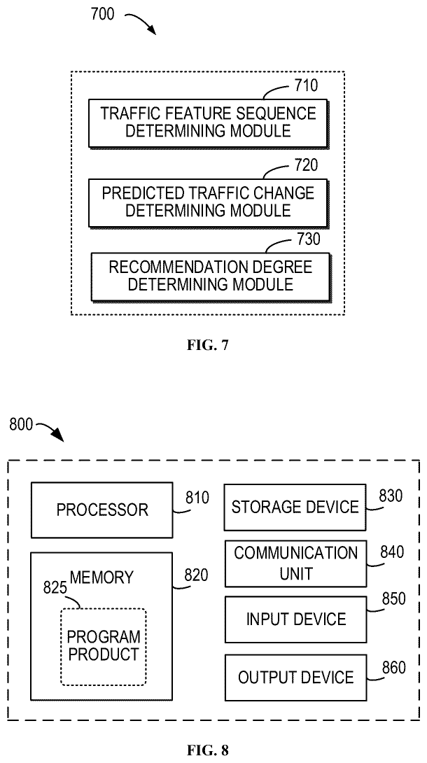

The embodiments of the present disclosure further provide a corresponding apparatus for implementing the above method or process. FIG. 7 shows a schematic structural block diagram of an apparatus 700 for live streaming recommendation according to some embodiments of the present disclosure. The apparatus 700 may be implemented as or included in the content recommendation system 150. Each module/component in the apparatus 700 may be implemented by hardware, software, firmware, or any combination thereof.

Referring to FIG. 7, the apparatus 700 includes a traffic feature sequence determining module 710, a predicted traffic change determining module 720, and a recommendation degree determining module 730. The traffic feature sequence determining module 710 is configured to determine a plurality of traffic feature sequences of a live stream that correspond to a plurality of interaction operations, where the plurality of interaction operations is initiated by viewer users in the live stream, and in each of the plurality of traffic feature sequences, different traffic features represent feature information corresponding to interaction operations in different historical time slices of the live stream. The predicted traffic change determining module 720 is configured to determine at least based on the plurality of traffic feature sequences, predicted traffic changes of the live stream respectively corresponding to the plurality of interaction operations in a target time slice. The recommendation degree determining module 730 is configured to a recommendation degree of the live stream for a user group at least based on a recommendation request of the user group and the predicted traffic changes of the live stream respectively corresponding to the plurality of interaction operations in the target time slice.

In some embodiments, the predicted traffic change determining module 720 is further configured to: determine a dependency between each traffic feature in the plurality of traffic feature sequences and other traffic features except the traffic feature; extract a first feature representation of the plurality of traffic feature sequences based on the determined dependency; and determine, at least based on the first feature representation, the predicted traffic changes of the live stream respectively corresponding to the plurality of interaction operations in the target time slice.

In some embodiments, the dependency between at least one traffic feature and other traffic features except the traffic feature includes at least a first dependency and a second dependency; and where the first dependency indicates a dependency between traffic features corresponding to different interaction operations in the same historical time slice, and the second dependency indicates a dependency between traffic features belonging to different historical time slices in the same traffic feature sequence.

In some embodiments, the predicted traffic change determining module 720 is further configured to: extract, from the plurality of traffic feature sequences, a plurality of graph structure representations corresponding to a plurality of historical time slices of the live stream from based on the determined dependency, where for a given graph structure representation corresponding to a given historical time slice, nodes in the given graph structure representation correspond to traffic features belonging to the given historical time slice in the plurality of traffic feature sequences, and an edge between at least two nodes in the given graph structure representation is determined based on a dependency between corresponding two traffic features; and determine the first feature representation through feature encoding based on a dependency between the plurality of graph structure representations.

In some embodiments, the plurality of graph structure representations is extracted from the plurality of traffic feature sequences at least by graph diffusion convolution; and/or the dependency between the plurality of graph structure representations is determined at least by a first machine learning model with a multi-head attention mechanism.

In some embodiments, the predicted traffic change determining module 720 is further configured to: determine the predicted traffic changes of the live stream respectively corresponding to the plurality of interaction operations, in the target time slice by a second machine learning model based on the plurality of traffic feature sequences and at least one of: discrete feature information related to the live stream, or dense feature information related to the livestreaming and/or the plurality of interaction operations.

In some embodiments, the recommendation degree determining module 730 is further configured to: an adjusting recommendation score for the live stream based on the predicted traffic changes respectively corresponding to the plurality of interaction operations, wherein the adjusting recommendation score indicates an overall traffic change of the live stream corresponding to the plurality of interaction operations in the target time slice; and determine t the recommendation degree of the live stream for the user group based on a reference recommendation score of the live stream for the user group and the adjusting recommendation score.

In some embodiments, the recommendation degree is positively related to the overall traffic change indicated by the adjustment recommendation score.

In some embodiments, the apparatus 600 further includes a ranking control module. The ranking control module is configured to: target push traffic associated with the live stream in the target time slice based on the predicted traffic changes respectively corresponding to the plurality of interaction operations; determine a traffic control score of the live stream in the target time slice at least based on the adjusted target push traffic and consumed push traffic associated with the live stream; and determine a ranking of the live stream in a live streaming push sequence for the user group at least based on the traffic control score of the live stream and the recommendation degree.

In some embodiments, the ranking control module is configured to: determine an adjusting recommendation score for the live stream based on the predicted traffic changes respectively corresponding to the plurality of interaction operations, wherein the adjusting recommendation score indicates an overall traffic change of the live stream corresponding to the plurality of interaction operations in the target time slice; increase the target push traffic by a first value in response to the adjusting recommendation score indicating that an overall traffic of the live stream corresponding to the plurality of interaction operations in the target time slice is going to increase and decrease the target push traffic by a second value in response to the adjusting recommendation score indicating that the overall traffic of the live stream corresponding to the plurality of interaction operations in the target time slice is going to decrease.

FIG. 8 shows a block diagram of an electronic device 800 in which one or more embodiments of the present disclosure may be implemented. The electronic device 800 may be used, for example, to implement the content recommendation system 150 shown in FIG. 1 or the apparatus 700 shown in FIG. 7. It should be understood that the electronic device 800 shown in FIG. 8 is only illustrative, and should not constitute any limitation on the function and scope of the embodiments described herein.

Referring to FIG. 8, the electronic device 800 is in the form of a general electronic device. The components of the electronic device 800 may include, but are not limited to, one or more processors or processors 810, a memory 820, a storage device 830, one or more communication units 840, one or more input devices 850, and one or more output devices 860. The processor 810 may be an actual or virtual processor and may execute various processes based on the programs stored in the memory 820. In a multi-processor system, multiple processors execute computer executable instructions in parallel to improve the parallel processing capability of the electronic device 800.

The electronic device 800 typically includes multiple computer storage medium. Such medium may be any available medium that is accessible to the electronic device 800, including but not limited to volatile and non-volatile medium, removable and non-removable medium. The memory 820 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 830 may be any removable or non-removable medium, and may include a machine-readable medium such as a flash drive, a disk, or any other medium, which may be used to store information and/or data and may be accessed within the electronic device 800.

The electronic device 800 may further include other removable/non-removable, volatile/non-volatile storage medium. Although not shown in FIG. 8, a disk drive for reading from or writing to a removable, non-volatile disk (for example, a “floppy disk”), and an optical disk drive for reading from or writing to a removable, non-volatile optical disk may be provided. In these cases, each drive may be connected to the bus (not shown) by one or more data medium interfaces. The memory 820 may include a computer program product 825, which has one or more program modules configured to perform various methods or actions of the various embodiments of the present disclosure.

The communication unit 840 implements communication with other electronic devices through the communication medium. In addition, the functions of the components of the electronic device 800 may be implemented with a single computing cluster or multiple computing machines, which may communicate through a communication connection. Therefore, the electronic device 800 may use the logical connection with one or more other servers, network personal computers (PCs) or another network node to operate in a networked environment.

The input device 850 may be one or more input devices, such as a mouse, a keyboard, a tracking ball, etc. The output device 860 may be one or more output devices, such as a display, a speaker, a printer, etc. The electronic device 800 may also communicate with one or more external devices (not shown) as needed through the communication unit 840, external devices such as the storage device, the display device, etc., communicate with one or more devices that allow the user to interact with the electronic device 800, or communicate with any device (for example, a network card, a modem, etc.) that allows the electronic device 800 to communicate with one or more other electronic devices. Such communication may be performed via input/output (I/O) interfaces (not shown).

According to an example implementation of the present disclosure, a computer-readable storage medium is provided, on which computer-executable instructions are stored, where the computer-executable instructions are executed by a processor to implement the method described above. According to an example implementation of the present disclosure, there is also provided a computer program product, the computer program product being tangibly stored on a non-transitory computer-readable medium and including computer-executable instructions, and the computer-executable instructions being executed by a processor to implement the method described above.

Aspects of the present disclosure are described herein with reference to flowcharts and/or block diagrams of methods, apparatus, devices and computer program products implemented according to the present disclosure.

It should be understood that each block of the flowcharts and/or block diagrams, and combinations of blocks in the flowcharts and/or block diagrams may be implemented by computer-readable program instructions.

These computer-readable program instructions may be provided to a processor of a general computer, a special computer or other programmable data processing apparatus to produce a machine, such that these instructions, when executed by the processor of the computer or other programmable data processing apparatus, produce an apparatus for implementing the functions/actions specified in one or more blocks of the flowcharts and/or block diagrams. These computer-readable program instructions may also be stored in a computer-readable storage medium, these instructions cause the computer, the programmable data processing apparatus and/or other devices to work in a specific manner, and thus, the computer-readable medium storing instructions includes a manufactured product, which includes instructions for implementing various aspects of the functions/actions specified in one or more blocks of the flowcharts and/or block diagrams.

The computer-readable program instructions may be loaded onto a computer, other programmable data processing apparatus, or other devices, so that a series of operation steps are performed on the computer, other programmable data processing apparatus, or other devices to produce a computer-implemented process, thereby enabling the instructions executed on the computer, other programmable data processing apparatus, or other devices to implement the functions/actions specified in one or more blocks of the flowcharts and/or block diagrams.

The flowcharts and block diagrams in the drawings show the architecture, functions, and operations of possible implementations of the systems, methods and computer program products according to the multiple implementations of the present disclosure. In this regard, each block in the flowchart or block diagram may represent a module, program segment, or part of an instruction, and the module, program segment, or part of an instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or flowchart, and combinations of blocks in the block diagram and/or flowchart may be implemented with a special hardware-based system that performs the specified functions or actions, or may be implemented with a combination of special hardware and computer instructions.

The implementations of the present disclosure have been described above, and the above description is illustrative, non-exhaustive, and not limited to the disclosed implementations. Many modifications and changes are obvious to those of ordinary skill in the art without departing from the scope and spirit of the described implementations. The determination of the terms used herein is intended to best explain the principles, actual applications, or improvements of the technology in the market of each implementation, or to enable other ordinary skilled in the art to understand the various implementations disclosed herein.

1. A method for live streaming recommendation, comprising:
determining a plurality of traffic feature sequences of a live stream that correspond to a plurality of interaction operations, wherein the plurality of interaction operations is initiated by viewer users in the live stream, and in each of the plurality of traffic feature sequences, different traffic features represent feature information corresponding to interaction operations in different historical time slices of the live stream;
determining, at least based on the plurality of traffic feature sequences, predicted traffic changes of the live stream respectively corresponding to the plurality of interaction operations in a target time slice; and
determining a recommendation degree of the live stream for a user group at least based on a recommendation request of the user group and the predicted traffic changes of the live stream respectively corresponding to the plurality of interaction operations in the target time slice.

2. The method of claim 1, wherein determining, at least based on the plurality of traffic feature sequences, the predicted traffic changes of the live stream respectively corresponding to the plurality of interaction operations in the target time slice comprises:
determining a dependency between each traffic feature in the plurality of traffic feature sequences and other traffic features except the traffic feature;
extracting a first feature representation of the plurality of traffic feature sequences based on the determined dependency; and
determining, at least based on the first feature representation, the predicted traffic changes of the live stream respectively corresponding to the plurality of interaction operations in the target time slice.

3. The method of claim 2, wherein the dependency between the at least one traffic feature and the other traffic features except the traffic feature at least comprises a first dependency and a second dependency; and
wherein the first dependency indicates a dependency between traffic features corresponding to different interaction operations in the same historical time slice, and the second dependency indicates a dependency between traffic features belonging to different historical time slices in the same traffic feature sequence.

4. The method of claim 2, wherein extracting the first feature representation of the plurality of traffic feature sequences comprises:
extracting, from the plurality of traffic feature sequences, a plurality of graph structure representations corresponding to a plurality of historical time slices of the live stream based on the determined dependency, wherein for a given graph structure representation corresponding to a given historical time slice, nodes in the given graph structure representation correspond to traffic features belonging to the given historical time slice in the plurality of traffic feature sequences, and an edge between at least two nodes in the given graph structure representation is determined based on a dependency between corresponding two traffic features; and
determining the first feature representation by feature encoding based on a dependency between the plurality of graph structure representations.

5. The method of claim 4, wherein the plurality of graph structure representations is extracted from the plurality of traffic feature sequences at least by graph diffusion convolution; and/or
wherein the dependency between the plurality of graph structure representations is determined at least by a first machine learning model with a multi-head attention mechanism.

6. The method of claim 1, wherein determining the predicted traffic changes of the live stream respectively corresponding to the plurality of interaction operations in the target time slice comprises:
determining the predicted traffic changes of the live stream respectively corresponding to the plurality of interaction operations in the target time slice by a second machine learning model based on the plurality of traffic feature sequences and at least one of:
discrete feature information related to the live stream, or
dense feature information related to the live stream and/or the plurality of interaction operations.

7. The method of claim 1, wherein determining the recommendation degree of the live stream for the user group comprises:
determining an adjusting recommendation score for the live stream based on the predicted traffic changes respectively corresponding to the plurality of interaction operations, wherein the adjusting recommendation score indicates an overall traffic change of the live stream corresponding to the plurality of interaction operations in the target time slice; and
determining the recommendation degree of the live stream for the user group based on a reference recommendation score of the live stream for the user group and the adjusting recommendation score.

8. The method of claim 7, wherein the recommendation degree is positively related to the overall traffic change indicated by the adjusting recommendation score.

9. The method of claim 1, further comprising:
adjusting target push traffic associated with the live stream in the target time slice based on the predicted traffic changes respectively corresponding to the plurality of interaction operations;
determining a traffic control score of the live stream in the target time slice at least based on the adjusted target push traffic and consumed push traffic associated with the live stream; and
determining a ranking of the live stream in a live streaming push sequence for the user group at least based on the traffic control score of the live stream and the recommendation degree.

10. The method of claim 9, wherein adjusting the target push traffic associated with the live stream comprises:
determining an adjusting recommendation score for the live stream based on the predicted traffic changes respectively corresponding to the plurality of interaction operations, wherein the adjusting recommendation score indicates an overall traffic change of the live stream corresponding to the plurality of interaction operations in the target time slice;
increasing the target push traffic by a first value in response to the adjusting recommendation score indicating that an overall traffic of the live stream corresponding to the plurality of interaction operations in the target time slice is going to increase; and
decreasing the target push traffic by a second value in response to the adjusting recommendation score indicating that the overall traffic of the live stream corresponding to the plurality of interaction operations in the target time slice is going to decrease.

11. An electronic device, comprising:
at least one processor; and
at least one memory coupled to the at least one processor and storing instructions executable by the at least one processor, wherein the instructions, when executed by the at least one processor, cause the electronic device to perform acts comprising:
determining a plurality of traffic feature sequences of a live stream that correspond to a plurality of interaction operations, wherein the plurality of interaction operations is initiated by viewer users in the live stream, and in each of the plurality of traffic feature sequences, different traffic features represent feature information corresponding to interaction operations in different historical time slices of the live stream;
determining, at least based on the plurality of traffic feature sequences, predicted traffic changes of the live stream respectively corresponding to the plurality of interaction operations in a target time slice; and
determining a recommendation degree of the live stream for a user group at least based on a recommendation request of the user group and the predicted traffic changes of the live stream respectively corresponding to the plurality of interaction operations in the target time slice.

12. The electronic device of claim 11, wherein determining, at least based on the plurality of traffic feature sequences, the predicted traffic changes of the live stream respectively corresponding to the plurality of interaction operations in the target time slice comprises:
determining a dependency between each traffic feature in the plurality of traffic feature sequences and other traffic features except the traffic feature;
extracting a first feature representation of the plurality of traffic feature sequences based on the determined dependency; and
determining, at least based on the first feature representation, the predicted traffic changes of the live stream respectively corresponding to the plurality of interaction operations in the target time slice.

13. The electronic device of claim 12, wherein the dependency between the at least one traffic feature and the other traffic features except the traffic feature at least comprises a first dependency and a second dependency; and
wherein the first dependency indicates a dependency between traffic features corresponding to different interaction operations in the same historical time slice, and the second dependency indicates a dependency between traffic features belonging to different historical time slices in the same traffic feature sequence.

14. The electronic device of claim 12, wherein extracting the first feature representation of the plurality of traffic feature sequences comprises:
extracting, from the plurality of traffic feature sequences, a plurality of graph structure representations corresponding to a plurality of historical time slices of the live stream based on the determined dependency, wherein for a given graph structure representation corresponding to a given historical time slice, nodes in the given graph structure representation correspond to traffic features belonging to the given historical time slice in the plurality of traffic feature sequences, and an edge between at least two nodes in the given graph structure representation is determined based on a dependency between corresponding two traffic features; and
determining the first feature representation by feature encoding based on a dependency between the plurality of graph structure representations.

15. The electronic device of claim 14, wherein the plurality of graph structure representations is extracted from the plurality of traffic feature sequences at least by graph diffusion convolution; and/or
wherein the dependency between the plurality of graph structure representations is determined at least by a first machine learning model with a multi-head attention mechanism.

16. The electronic device of claim 11, wherein determining the predicted traffic changes of the live stream respectively corresponding to the plurality of interaction operations in the target time slice comprises:
determining the predicted traffic changes of the live stream respectively corresponding to the plurality of interaction operations in the target time slice by a second machine learning model based on the plurality of traffic feature sequences and at least one of:
discrete feature information related to the live stream, or
dense feature information related to the live stream and/or the plurality of interaction operations.

17. The electronic device of claim 11, wherein determining the recommendation degree of the live stream for the user group comprises:
determining an adjusting recommendation score for the live stream based on the predicted traffic changes respectively corresponding to the plurality of interaction operations, wherein the adjusting recommendation score indicates an overall traffic change of the live stream corresponding to the plurality of interaction operations in the target time slice; and
determining the recommendation degree of the live stream for the user group based on a reference recommendation score of the live stream for the user group and the adjusting recommendation score.

18. The electronic device of claim 17, wherein the recommendation degree is positively related to the overall traffic change indicated by the adjusting recommendation score.

19. The electronic device of claim 11, wherein the acts further comprise:
adjusting target push traffic associated with the live stream in the target time slice based on the predicted traffic changes respectively corresponding to the plurality of interaction operations;
determining a traffic control score of the live stream in the target time slice at least based on the adjusted target push traffic and consumed push traffic associated with the live stream; and
determining a ranking of the live stream in a live streaming push sequence for the user group at least based on the traffic control score of the live stream and the recommendation degree.

20. A computer-readable storage medium having computer-executable instructions stored thereon, wherein the computer-executable instructions are executable by a processor to implement acts comprising:
determining a plurality of traffic feature sequences of a live stream that correspond to a plurality of interaction operations, wherein the plurality of interaction operations is initiated by viewer users in the live stream, and in each of the plurality of traffic feature sequences, different traffic features represent feature information corresponding to interaction operations in different historical time slices of the live stream;
determining, at least based on the plurality of traffic feature sequences, predicted traffic changes of the live stream respectively corresponding to the plurality of interaction operations in a target time slice; and
determining a recommendation degree of the live stream for a user group at least based on a recommendation request of the user group and the predicted traffic changes of the live stream respectively corresponding to the plurality of interaction operations in the target time slice.
